(19) United States
(12) Patent Application Publication
(10) Pub. No.: US 2011/0209687 A1
(43) Pub. Date: Sep. 1, 2011

(54) HIGH-PRESSURE FUEL PUMP FOR AN INTERNAL COMBUSTION ENGINE

(76) Inventors: Bernd Schroeder, Esslingen (DE); Berthold Pfuhl, Markgroeningen (DE); Peter Ropertz, Oberriexingen (DE)

(21) Appl. No.: 13/126,354

(22) PCT Filed: Sep. 14, 2009
(86) PCT No.: PCT/EP2009/061875

§ 371 Date: Apr. 27, 2011

(30) Foreign Application Priority Data
Oct. 28, 2008 (DE) 102008043217.2

(51) Int. Cl. F02M 69/00

(52) U.S. Cl. 123/459

(57) ABSTRACT

The invention relates to a high-pressure fuel pump for an internal combustion engine with direct injection, comprising a pump housing, a low-pressure region on the intake side, and a high-pressure region on the output side. The high-pressure fuel pump comprises a purely mechanical pressure regulating device for regulating a constant pressure in the high-pressure region.

### PRIOR ART

The invention relates to a high-pressure fuel pump for an internal combustion engine as generically defined by the preamble to claim 1.

High-pressure fuel pumps with direct injection typically have a low-pressure region and a high-pressure region. An electric prefeed pump feeds the fuel from a tank into the low-pressure region, from which the fuel is fed via the high-pressure fuel pump into a fuel collection line (called “common rail”) that communicates with the high-pressure region. The pressure in the common rail is typically regulated by a pressure regulating and/or quantity control valve, and the valves are controlled by a control and/or regulating device, among other ways via an evaluation of signals of a pressure sensor. The pressure regulating valve can also function mechanically.

From European Patent Disclosures EP 0 299 337 A2, EP 0 837 986 B1, EP 0 974 008 B1, and German Patent Disclosure DE 196 12 413 A1, devices for regulating the fuel pressure are already known.

From German Patent Disclosure DE 103 27 411 A1, a pressure limiting valve is known for a high-pressure fuel pump that has a pressure limiting valve.

### DISCLOSURE OF THE INVENTION

The object of the invention is to create and further refine a high-pressure fuel pump for an internal combustion engine of the type defined at the outset, which functions reliably and is compact in construction. Moreover, the high-pressure fuel pump should be economical.

This object is attained by a high-pressure fuel pump for an internal combustion engine having the characteristics of claim 1. Characteristics important to the invention are also found in the ensuing description and in the drawings; the characteristics may be important for the invention both on their own and in various combinations, without this being referred to in each case explicitly. Advantageous refinements are found in the dependent claims.

Because of the design of the high-pressure fuel pump, on the one hand space in the engine region of a motor vehicle is saved, and on the other, by skilled integration of the pressure regulating device with the high-pressure fuel pump, the known external dimensions of the high-pressure fuel pump can be kept unchanged. No additional hydraulic lines are needed. This advantageously leads to a very compact construction of the high-pressure fuel pump. Because controlling the fuel quantity is dispensed with, the high-pressure fuel pump also needs no quantity control valve with an associated end stage and an electrical trigger line. The pressure sensor required for electronic control can also be dispensed with. This makes the invention especially economical and also economizes on engine performance. Since the unneeded quantity of fuel is diverted into the low-pressure region, a pressure limiting function is ensured as well.

The present invention is based on the idea that when a less pressure-sensitive fuel system is used in an internal combustion engine, such as a constant-pressure system, complicated electronic quantity control of fuel can be dispensed with. On this condition, the pressure regulation in the high-pressure region is then done via a mechanical pressure regulating device, which is integrated with the high-pressure pump. The pressure regulating device is disposed hydraulically between the low-pressure region and the high-pressure region. Once a previously adjustable opening pressure of the pressure regulating device is reached, the unneeded quantity of fuel is returned from the high-pressure region to the low-pressure region. As a result, in engine operation, an at least substantially constant pressure is established on the high-pressure side.

In a first refinement, it is proposed that the mechanical pressure regulating device includes a mechanical pressure regulating valve, in particular a mechanical check valve, for instance subjected to a spring. Mechanical pressure regulating valves are relatively simple in construction, reliable, and thus economical. This is true particularly for check valves. Such a valve is moreover extremely small and therefore can be integrated without problems into the high-pressure fuel pump.

It is especially advantageous if a mechanical throttle restriction is disposed upstream of a valve element of the pressure regulating device, so that adverse effects on the regulating performance in the common rail, especially of single-cylinder fuel pumps are used, from unwanted pressure pulsations of the high-pressure pump are reduced. Wear to the pressure regulating valve is thus reduced as well. The throttle restriction can be embodied as a separate throttle element or other cross-sectional constriction in an inflow conduit on the high-pressure side, a valve body, or a receiving opening in the pump housing.

It is also proposed that the pressure regulating valve is disposed off-center in the pump housing of the high-pressure fuel pump, in a bore, and that optionally a connecting bore from the pressure regulating valve to the high-pressure region is also disposed off-center. The middle, central region in the pump housing is reserved in a known fashion for the actual pumping functions of the high-pressure fuel pump. In the off-center region, however, there is enough room to integrate the pressure regulating function. This makes the high-pressure fuel pump into a very effectively usable, compact device. Moreover, this makes machining of the pump housing easier.

It is also proposed that a limit pressure in the high-pressure region is fixed by means of a valve spring and/or a sealing diameter between the valve element and the valve seat of the pressure regulating device. This means that in the design of the pressure regulating device, and optionally upon assembly of the high-pressure fuel pump, the limit pressure can be set precisely. Accordingly, no calibration of the completed high-pressure fuel pump, or even a high-pressure fuel pump already built into a motor vehicle, is needed.

In addition, it is proposed that the pressure regulating device has a cartridgelike valve housing. Thus the pressure regulating device can be manufactured and adjusted as a separate component unit and then fitted into the pump housing and kept between the sleeve and the pump housing, for instance by way of a press fit. Adjusting the function of the pressure regulating valve is simpler, since among other factors, when the opening pressure is hydraulically set, there is no need also to clean the pump housing for further assembly steps. Moreover, if an incorrect setting occurs, it does not mean the rejection of the pump housing as well.

It is also advantageous if the inlet valve is disposed coaxially to the pump piston of the high-pressure fuel pump. This makes it possible to achieve a high delivery rate of fuel from the low-pressure region, which can be even further increased if, between a pressure damper of the high-pressure fuel pump and the inlet valve, the diameter of the corresponding connecting bore is relatively large compared to the opening of the inlet valve.

### BRIEF DESCRIPTION OF THE DRAWINGS

Below, in conjunction with the drawings, exemplary embodiments of the invention are described as examples. Shown are:

FIG. 1, a schematic illustration of a fuel system with a high-pressure fuel pump;

FIG. 2, a perspective view of the high-pressure fuel pump of FIG. 1;

FIG. 3, a fragmentary longitudinal section through the high-pressure fuel pump of FIG. 1, with an inlet region shown in section;

FIG. 4, a longitudinal section through the high-pressure fuel pump of FIG. 1, with an outlet region shown in section;

FIG. 5, a longitudinal section through the high-pressure fuel pump of FIG. 1, with a pressure regulating valve shown in section (sectional plane V-V in FIG. 6);

FIG. 6, a cross section through the high-pressure fuel pump of FIG. 1; and

FIG. 7, an illustration similar to FIG. 5 of a variant of the high-pressure fuel pump of FIG. 2.

### DETAILED DESCRIPTION

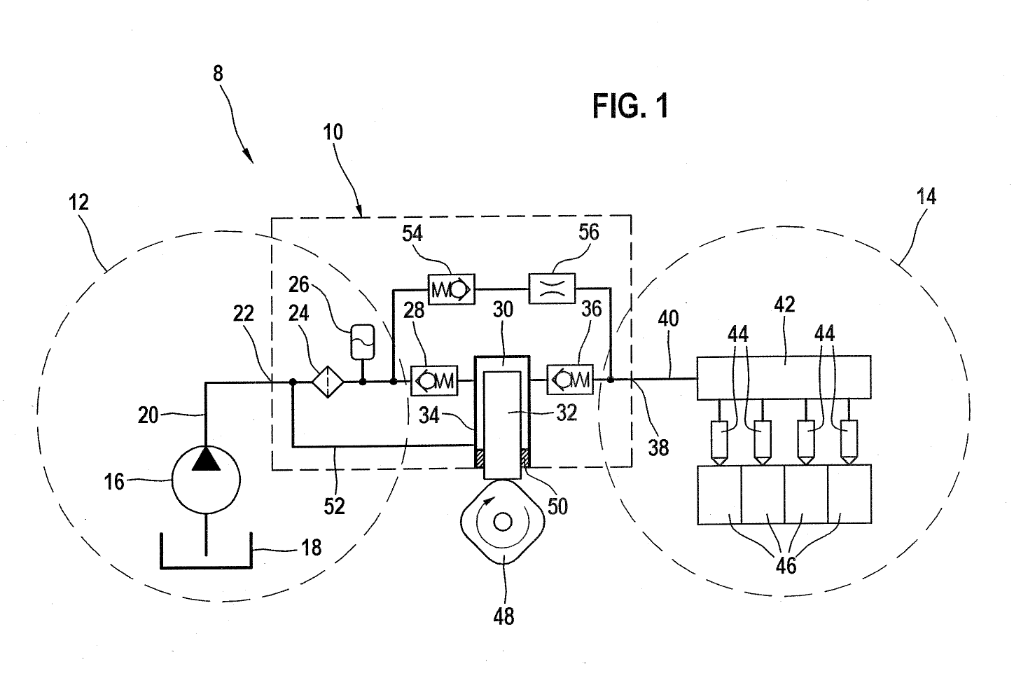

The construction and general function of the high-pressure fuel pump of the invention will be described in its main aspects in conjunction with FIG. 1. FIG. 1 is a schematic illustration of a fuel system 8 for an internal combustion engine (not shown) having a high-pressure fuel pump 10. The fuel system, as will also be discussed hereinafter, is subdivided in a low-pressure region 12, shown on the left in FIG. 1, and a high-pressure region 14, shown on the right. A prefeed pump 16 disposed in the low-pressure region 12 pumps fuel from a fuel tank 18 via a low-pressure line 20 at a prefeed pressure to an inlet stub 22 of the high-pressure fuel pump 10. In the high-pressure fuel pump 10, a filter 24 and a pressure damper 26 are disposed in the low-pressure region 12. The pressure damper 26 damps pulsations on the low-pressure side that occur in the high-pressure fuel pump 10 and ensures a high delivery rate even at high rotary and cam speeds.

Via an inlet valve 28, the fuel is aspirated into a work chamber 30 of the high-pressure fuel pump 10. The volume of the work chamber 30 depends on the position of a pump piston 32 and a pump cylinder 34. During a downward motion of the pump piston 32, the work chamber 30 is increased in size, and as a result fuel is aspirated. During the upward motion of the pump piston 32, the fuel is highly compressed and is fed via an outlet valve 36 and an outlet stub 38, belonging to the high-pressure region 14, onward via a high-pressure line 40 into a rail 42. Injection valves 44 are connected to the rail 42 and inject the fuel directly into the combustion chambers 46 of the engine.

The pump piston 32 is driven via a cam 48, which is driven by the engine—for instance via a camshaft or crankshaft (not shown). The cam 48 can also be part of the camshaft or crankshaft. Sealing off the pump piston 32 from the cam 48 is effected via a sealing element 50. Piston leakage that occurs in the gap between the pump piston 32 and the pump cylinder 34 is returned to the low-pressure region 12 via a return line 52.

Since in normal operation the feed quantity of the pump piston 32 is greater than the injected fuel quantity, an unneeded quantity of fuel on the high-pressure side 14 is returned to the low-pressure region 12 again via a purely mechanically functioning pressure regulating valve 54. The pressure in the common rail 42 thus substantially corresponds to the opening pressure of the pressure regulating valve 54.

In the high-pressure region 14 as well, pulsations occur, especially if single-cylinder pumps are used. These pulsations can adversely affect the pressure regulating function in the rail 42. For decoupling, a throttle restriction 56 is disposed hydraulically upstream of the pressure regulating valve 54, and as a result, the pulsations upstream of the pressure regulating valve 54 and wear of that valve are reduced.

The following drawings show the construction of the high-pressure fuel pump 10 in perspective or sectional views in greater detail. It should be pointed out that for reasons of simplicity and clarity, not all components are identified by reference numerals in all the figures.

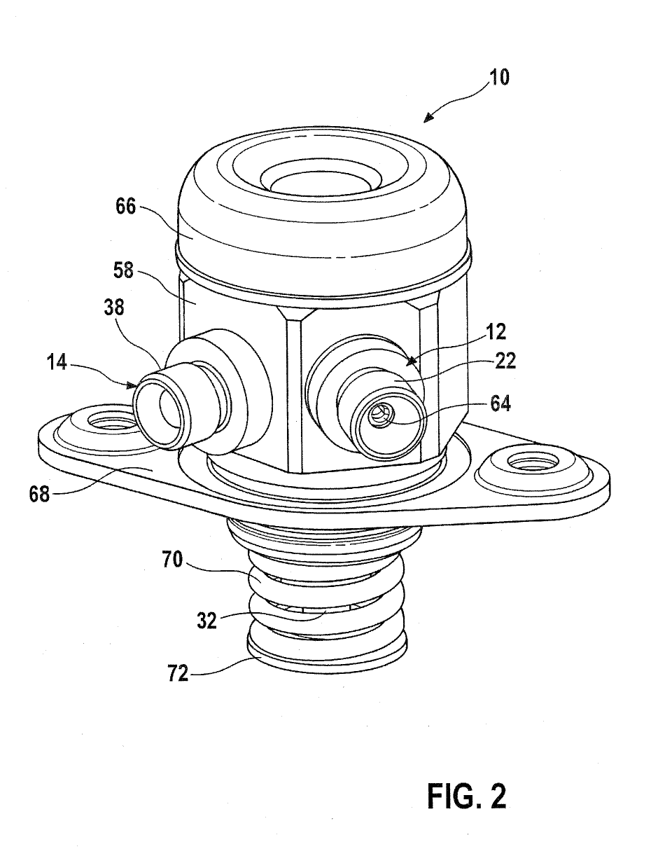

FIG. 2 shows the high-pressure fuel pump 10 in a perspective view. The inlet stub 22 (low-pressure region 12) and the outlet stub 38 (high-pressure region 14) are disposed on a pump housing 58. A filter 64 is integrated with the inlet stub 22. The high-pressure fuel pump 10 further includes an inwardly-indented cap 66 and a flange plate 68 for securing the high-pressure fuel pump 10, for instance to a cylinder head of the engine. Both parts 66 and 68 are solidly connected to the pump housing 58. The pump piston 32 protrudes downward out of the pump housing 58. A piston spring 70 is braced on one end on a spring plate 72 solidly connected to the pump piston 32, and is braced on the other end (not visible) on the pump housing 58. The force of the piston spring 70 is accordingly introduced into the pump piston 32 via the spring plate 72. It is thus ensured that in operation, the pump piston 32 always follows the contour of the cam.

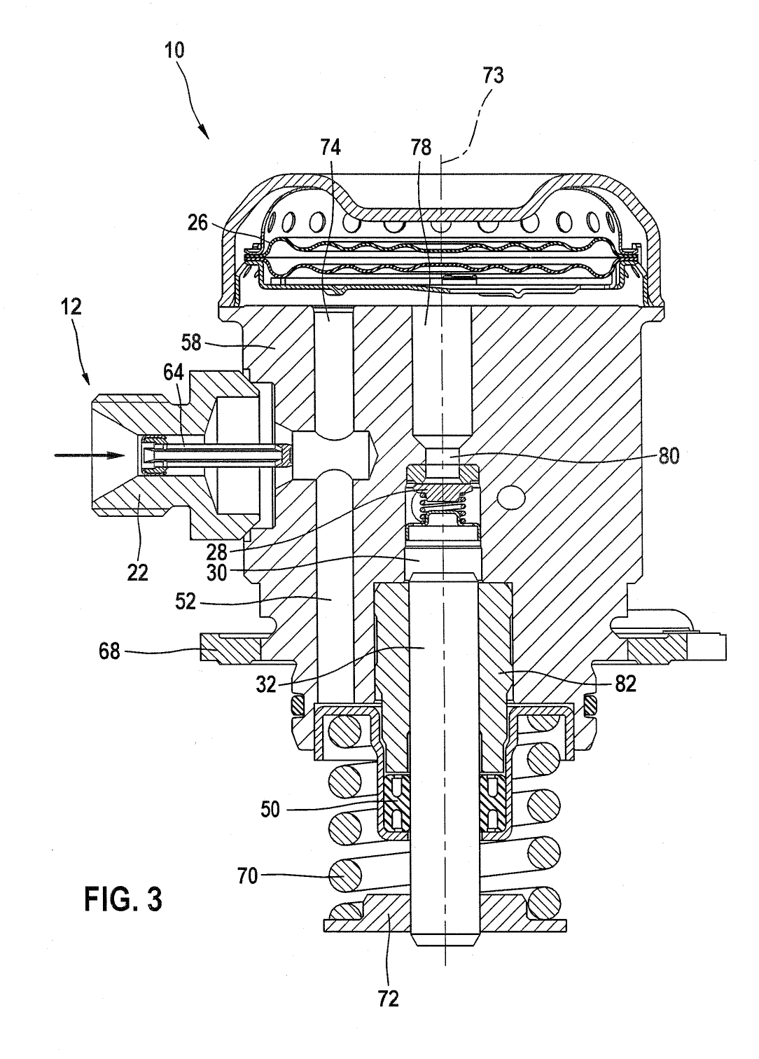

As can be seen from FIG. 3, the inlet stub 22 with the filter 64 communicates, via a bore 74 that is eccentric to a longitudinal axis 73 of the pump housing 58, with a receiving chamber (not identified by reference numeral) for the pressure damper 26, the receiving chamber being located below the cap 66. The receiving chamber in turn can be made to communicate with the pump work chamber 30, via two bore segments 78 and 80, which are coaxial with the pump housing 58, and via the inlet valve 28. The pump piston 32 is displaceably supported in a cylinder bush 82. During an intake phase of the pump piston 32, the fuel reaches the pump work chamber 30 via the bores 78 and 80 and the inlet valve 28.

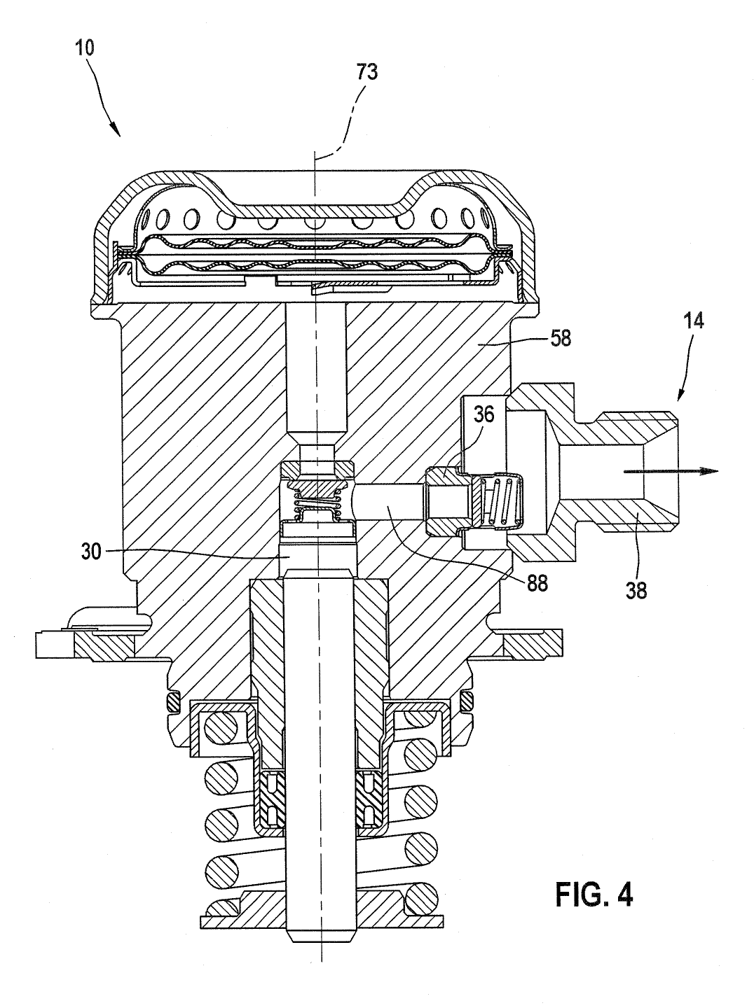

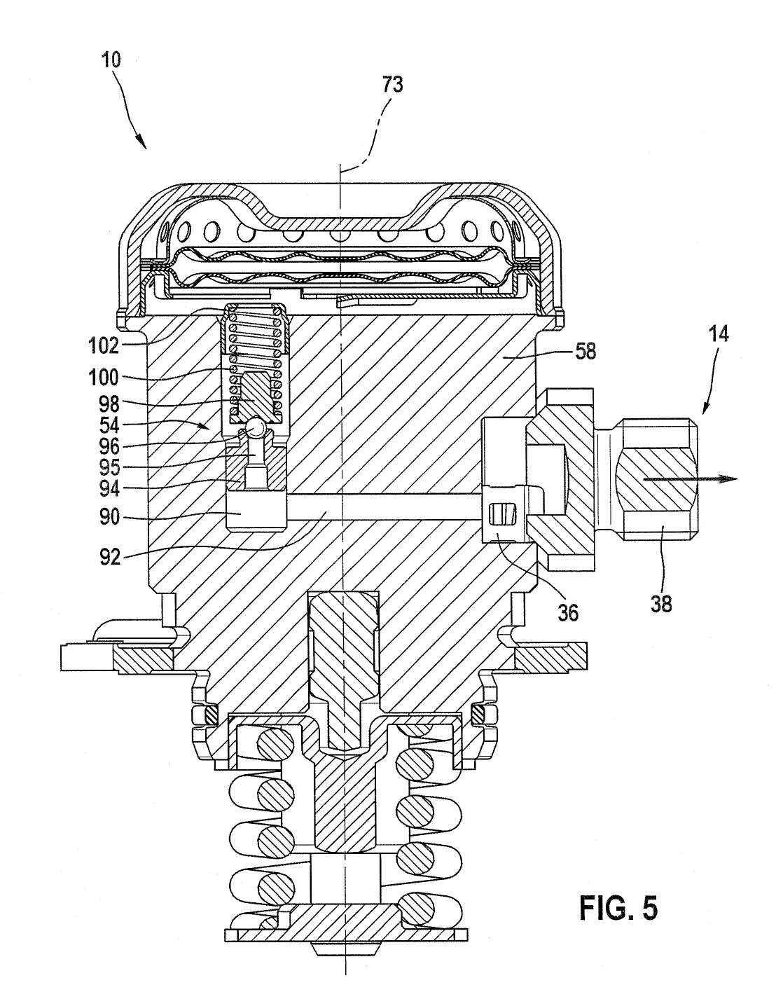

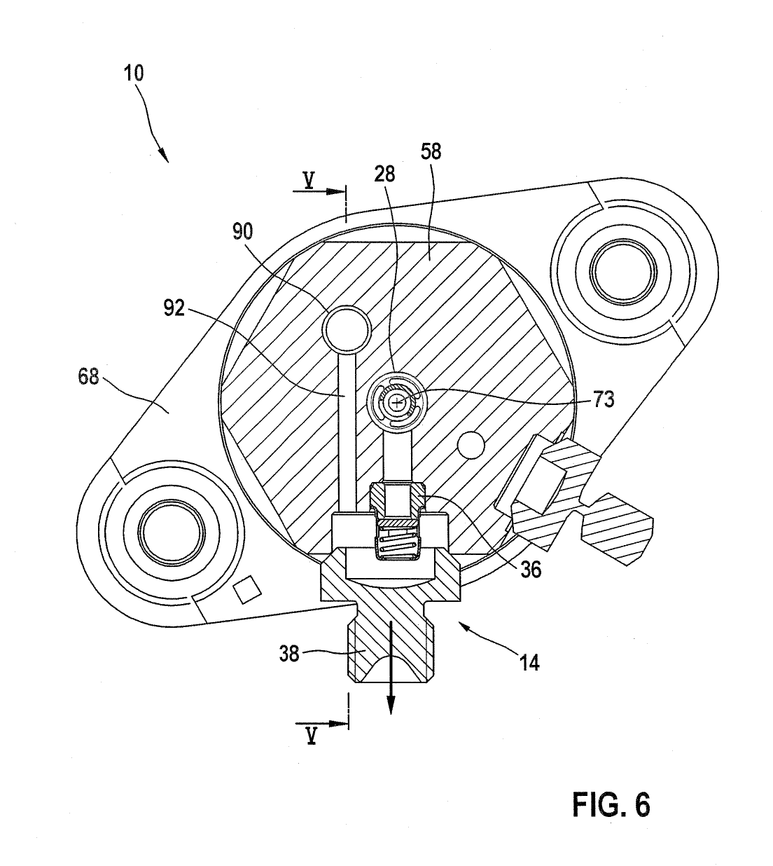

As seen from FIG. 4, the pump work chamber 30 and the outlet valve 36 communicate hydraulically with one another via a bore 88 in the pump housing 58. From FIGS. 5 and 6, it can be seen that the pressure regulating valve 54 in the pump housing 58 is disposed eccentrically in a bore 90 and parallel to the longitudinal axis 73. Accordingly, the sectional plane in FIG. 4 is not central; instead, it is spaced apart from the longitudinal axis 73. On the high-pressure side, the pressure regulating valve 54 communicates with the outlet valve 36 via a bore 92 that is also spaced apart from the longitudinal axis 73. On the outlet side, the pressure regulating valve 54 communicates via the bore 90 with the receiving chamber for the pressure damper 26. The pressure regulating valve 54 includes a valve seat (not identified by reference numeral) on a valve seat body 94 having an inflow bore 95, and also includes a ball valve body 96, a spring guide 98, a valve spring 100, and a spring holder 102.

The valve seat body 94 is solidly anchored in the bore 90, for instance via a press fit. Via the spring guide 98, the valve spring 100 presses the valve body 96 into the valve seat. In FIG. 5, the valve body is ball-shaped. Depending on the spring force and the sealing diameter between the valve body 96 and the valve seat 94, a defined opening pressure results. In the upper part of FIG. 5, the valve spring 100 is braced on the spring holder 102. The spring holder 102 is in turn solidly anchored in the bore 90 (for instance via a press fit). Upon the assembly of the pressure regulating valve 54, the opening pressure is set by way of the press-fit travel distance of the spring holder 102.

The high-pressure fuel pump 10 functions as follows: Upon a downward motion of the pump piston 32 (“intake stroke”), fuel is aspirated into the work chamber 30 via the inlet valve 28. Upon an upward motion (“delivery stroke”), the fuel in the work chamber 30 is compressed and is fed via the outlet valve 36 into the high-pressure line 40. If the pressure in the high-pressure region 14 exceeds the limit pressure of the pressure regulating valve 54, the latter opens because the valve body 96 lifts from the valve seat, so that fuel can flow away into the receiving chamber of the pressure damper 26 and thus into the low-pressure region 12. If the pressure in the high-pressure region 14 drops below the limit pressure of the pressure regulating valve 54, the latter closes again. In this way, the pressure in the high-pressure region 14 is kept essentially constant, namely at the limit pressure or opening pressure of the pressure regulating valve 54.

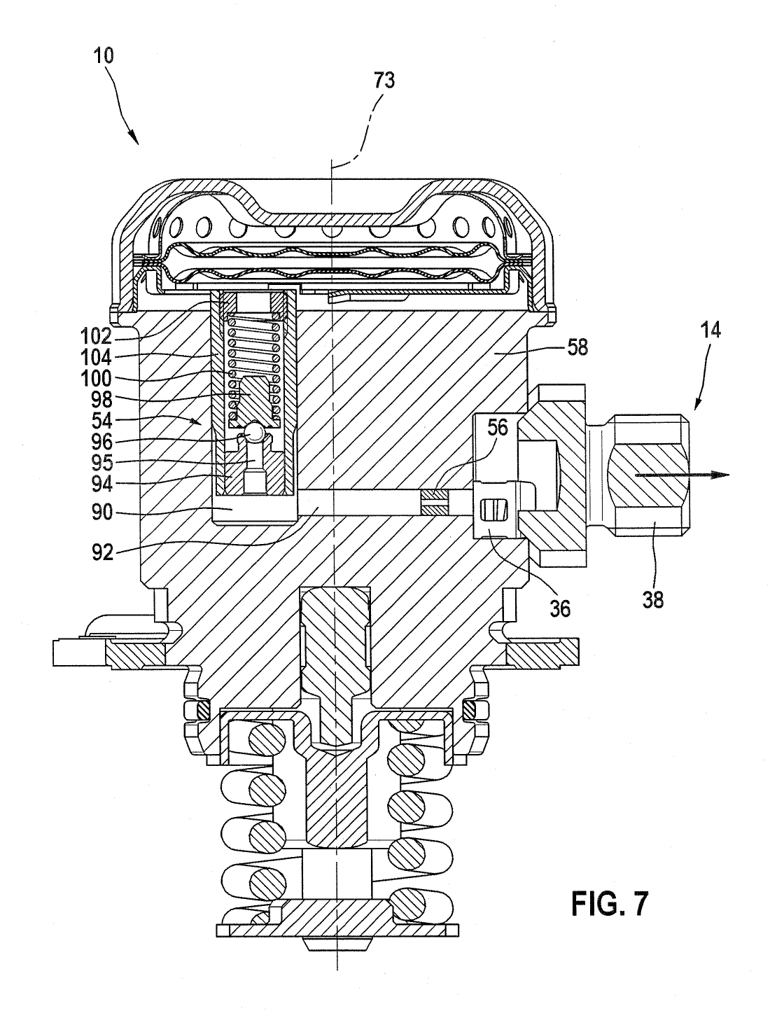

FIG. 7 shows a variant of the high-pressure fuel pump 10. In it, those elements and regions that have equivalent functions to elements and regions that have already been described are identified by the same reference numerals and will not be explained again.

In the alternative variant shown, the pressure regulating valve 54 is embodied in a cartridge version. The assembly of the pressure regulating valve 54 and the setting of the opening pressure can be done here outside the pump housing 58. The valve seat body 94 is fitted into a sleeve 104 and retained, for instance via a press fit. After the valve body 96, spring guide 98, and valve spring 100 are put together, the spring holder 102 is fitted into the sleeve 104 as well. Once again, the spring force and thus the opening pressure are set by the position of the spring holder 102. The spring holder 102 can, as shown in FIG. 7, be screwed into the sleeve 104. As an alternative to the screw-in version, a press fit is also possible. Once the pressure regulating valve 54 has been installed and set, it is fitted as a component unit into the pump housing 58 and retained, for instance via a press fit, between the sleeve 104 and the pump housing 58.

In the variant of the high-pressure fuel pump 10 shown in FIG. 7, a throttle restriction 56 is also positioned in the bore 92. It is also conceivable to dispose the throttle restriction 56 in the bore 90. As an alternative to the throttle restriction 56, the inflow bore 95 can also have a reduced cross section in some regions in the valve seat body 94, as a result of which once again a throttling function is achieved.

1-10. (canceled)

11. A high-pressure fuel pump for an internal combustion engine with direct injection, having:
a pump housing;
a low-pressure region on an inlet side of the hi-pressure fuel pump;
a high-pressure region on an outlet side of the hi-pressure fuel pump; and
a purely mechanical pressure regulating device for regulating a constant pressure in the high-pressure region.

12. The high-pressure fuel pump as defined by claim 11, wherein the mechanical pressure regulating device includes a mechanical pressure regulating valve, in particular a mechanical check valve.

13. The high-pressure fuel pump as defined by claim 11, wherein a throttle restriction is disposed upstream of a valve element of the pressure regulating device.

14. The high-pressure fuel pump as defined by claim 12, wherein a throttle restriction is disposed upstream of a valve element of the pressure regulating device.

15. The high-pressure fuel pump as defined by claim 13, wherein the throttle restriction is embodied in a valve seat housing of the pressure regulating valve and/or in a receiving opening in the pump housing for the pressure regulating device and/or in an inflow conduit to the pressure regulating device.

16. The high-pressure fuel pump as defined by claim 14, wherein the throttle restriction is embodied in a valve seat housing of the pressure regulating valve and/or in a receiving opening in the pump housing for the pressure regulating device and/or in an inflow conduit to the pressure regulating device.

17. The high-pressure fuel pump as defined by claim 11, wherein that the pressure regulating device is disposed in the cylindrical pump housing, in a bore disposed offset from a longitudinal axis of the pump housing.

18. The high-pressure fuel pump as defined by claim 12, wherein that the pressure regulating device is disposed in the cylindrical pump housing, in a bore disposed offset from a longitudinal axis of the pump housing.

19. The high-pressure fuel pump as defined by claim 13, wherein that the pressure regulating device is disposed in the cylindrical pump housing, in a bore disposed offset from a longitudinal axis of the pump housing.

20. The high-pressure fuel pump as defined by claim 15, wherein that the pressure regulating device is disposed in the cylindrical pump housing, in a bore disposed offset from a longitudinal axis of the pump housing.

21. The high-pressure fuel pump as defined by claim 11, further having a connecting bore of the pressure regulating device extending transversely to a longitudinal axis of the pump housing, the connecting bore being disposed between the pressure regulating device and the high-pressure region.

22. The high-pressure fuel pump as defined by claim 20, further having a connecting bore of the pressure regulating device extending transversely to a longitudinal axis of the pump housing, the connecting bore being disposed between the pressure regulating device and the high-pressure region

23. The high-pressure fuel pump as defined by claim 13, wherein the pressure regulating device has a valve spring and/or a sealing diameter between the valve element and a valve seat, by which a limit pressure in the high-pressure region is defined.

24. The high-pressure fuel pump as defined by claim 20, wherein the pressure regulating device has a valve spring and/or a sealing diameter between the valve element and a valve seat, by which a limit pressure in the high-pressure region is defined.

25. The high-pressure fuel pump as defined by claim 11, wherein the pressure regulating device has a cartridgelike valve housing, which is inserted, preferably press-fitted, into a receiving opening of the pump housing.

26. The high-pressure fuel pump as defined by claim 24, wherein the pressure regulating device has a cartridgelike valve housing, which is inserted, preferably press-fitted, into a receiving opening of the pump housing.

27. The high-pressure fuel pump as defined by claim 11, wherein an inlet valve is disposed coaxially to a pump piston of the high-pressure fuel pump.

28. The high-pressure fuel pump as defined by claim 26, wherein an inlet valve is disposed coaxially to a pump piston of the high-pressure fuel pump.

29. The high-pressure fuel pump as defined by claim 11, wherein an outlet of the pressure regulating device communicates with the low-pressure region of the high-pressure fuel pump, in particular with a receiving chamber of a pressure damper.

30. The high-pressure fuel pump as defined by claim 28, wherein an outlet of the pressure regulating device communicates with the low-pressure region of the high-pressure fuel pump, in particular with a receiving chamber of a pressure damper.
